(19) United States
(12) Patent Application Publication
(10) Pub. No.: US 2008/0158432 A1
(43) Pub. Date: Jul. 3, 2008

(54) Dmb Receiver and Receiving Method Using Human Body Antenna

(75) Inventors: Jung Hwan Hwang, Daejon-city (KR); Sung Weon Kang, Daejeon-city (KR); Chang Hee Hyoung, Daejeon-city (KR); Jin Bong Sung, Daejeon-city (KR); Duck Gun Park, Daejeon-city (KR); Jin Kyung Kim, Daejeon-city (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejon (KR)

(21) Appl. No.: 11/914,070

(22) PCT Filed: Mar. 13, 2006
(86) PCT No.: PCT/KR06/00883

§ 371 Date: Nov. 9, 2007

(30) Foreign Application Priority Data
May 11, 2005 (KR) 10-2005-0039231

(51) Int. Cl. H04N 5/44

(52) U.S. Cl. 348/725; 348/E05.096

(57) ABSTRACT

Provided is a T-DMB receiver and receiving method using a human body as an antenna. The T-DMB receiver includes: an electrode making contact with a human body; a low frequency amplifier receiving via the electrode a current flowing through the human body due to a DMB broadcasting signal emitted by a terrestrial relay station and amplifying the received current; and an impedance matching circuit located between the electrode and the low frequency amplifier and matching an impedance of the human body with an impedance of the low frequency amplifier. Accordingly, a T-DMB receiver easy to carry without a separate antenna can be implemented.

### TECHNICAL FIELD

The present invention relates to a terrestrial digital multimedia broadcasting (T-DMB) receiver and receiving method, and more particularly, to a T-DMB receiver and receiving method using a human body antenna.

### BACKGROUND ART

Digital multimedia broadcasting (DMB) provides various multimedia services, such as audio, video, and various kinds of data, to users traveling by car or on foot and is largely divided into terrestrial DMB (T-DMB) and satellite DMB (S-DMB).

According to T-DMB, a very high frequency (VHF) band, i.e. a 200 MHz band, signal is transmitted using broadcasting base stations currently used for analog TV broadcasting, and users receive the signal using their own T-DMB receivers. Various types of T-DMB receivers, such as vehicle, fixed, and portable T-DMB receivers, are used in T-DMB, and it is predicted that demands for portable T-DMB receivers or portable T-DMB receivers combined with cell phones will skyrocket.

The size of an antenna used for a T-DMB receiver is proportional to a wavelength of a used frequency. Since the T-DMB receiver uses a relatively low frequency band of 200 MHz, the T-DMB receiver must use a relatively large antenna compared to an antenna of a general wireless communication terminal using a frequency of more than 800 MHz. For example, for a monopole antenna widely used for wireless communication terminals, the antenna length is a quarter of a wavelength corresponding to a used frequency, and when this is applied to a T-DMB receiver using a 200 MHz band, the antenna length is around 37.5 cm, and therefore the antenna is too long for a user to carry the T-DMB receiver.

To solve this problem, the built-in antennas obtained by miniaturizing antennas using various antenna miniaturization techniques and installing them inside respective receivers have been suggested. Such built-in antennas are shorter than monopole antennas but have low receiving sensitivity due to inside installation of the receivers. In addition, when a user carries a receiver, since the receiver is close to the user, a receiving characteristic of the antenna is affected by the body of the user, and therefore, the receiving characteristic degrades due to variation of an input matching condition of the antenna.

### DISCLOSURE OF INVENTION

### Advantageous Effects

According to embodiments of the present invention, since a separate antenna is not necessary by using a human body as an antenna of a T-DMB receiver, the T-DMB receiver is easy to carry. In addition, by using a T-DMB relay apparatus or a separate antenna, a DMB broadcasting signal can be received even when the T-DMB receiver does not make contact with the human body.

### DESCRIPTION OF DRAWINGS

FIG. 1 is a diagram illustrating conductivities of tissues/organs comprising a human body at a T-DMB frequency band of 200 MHz;

FIG. 2 illustrates a human body model used to simulate an antenna characteristic of a human body;

FIGS. 3A and 3B are diagrams illustrating an antenna characteristic of a human body simulated using the human body model of FIG. 2;

FIG. 4 is a conceptual diagram of a T-DMB receiver using a human body as an antenna according to an embodiment of the present invention;

FIG. 5 is a block diagram of the T-DMB receiver of FIG. 4 using a human body as an antenna according to an embodiment of the present invention;

FIG. 6 is a conceptual diagram of a T-DMB receiver and relay apparatus using a human body as an antenna according to another embodiment of the present invention;

FIG. 7 is a block diagram of the T-DMB relay apparatus of FIG. 6 using a human body as an antenna according to an embodiment of the present invention;

FIG. 8 is a block diagram of a T-DMB receiver using a human body as an antenna according to another embodiment of the present invention;

FIG. 9 is a conceptual diagram of a T-DMB receiver using a human body as an antenna according to another embodiment of the present invention;

FIG. 10 is a block diagram of the T-DMB receiver of FIG. 9 using a human body as an antenna according to an embodiment of the present invention; and

FIG. 11 is a flowchart of a T-DMB receiving method using a human body as an antenna according to another embodiment of the present invention.

### BEST MODE

The present invention provides a terrestrial digital multimedia broadcasting (T-DMB) receiver and receiving method using a human body as an antenna so that the T-DMB receiver is easy to carry and has an excellent receiving characteristic.

According to an aspect of the present invention, there is provided a terrestrial digital multimedia broadcasting (T-DMB) receiver using a human body as an antenna, the T-DMB receiver comprising: an electrode making contact with a human body; a low frequency amplifier receiving via the electrode a current flowing through the human body due to a DMB broadcasting signal emitted by a terrestrial relay station and amplifying the received current; and an impedance matching circuit located between the electrode and the low frequency amplifier and matching an impedance of the human body with an impedance of the low frequency amplifier.

According to another aspect of the present invention, there is provided a terrestrial digital multimedia broadcasting (T-DMB) relay apparatus using a human body as an antenna, by which T-DMB data is relayed to a T-DMB receiver comprising a high frequency receiver receiving a signal of a high frequency band higher than a frequency of the T-DMB broadcasting, the T-DMB relay apparatus comprising: an electrode making contact with a human body; a low frequency amplifier receiving via the electrode a current flowing through the human body due to a DMB broadcasting signal and amplifying the received current; an impedance matching circuit located between the electrode and the low frequency amplifier and matching an impedance of the human body with an impedance of the low frequency amplifier; and a frequency up-converter converting the current amplified by the low frequency amplifier to a high frequency signal corresponding to the high frequency receiver of the T-DMB receiver.

According to another aspect of the present invention, there is provided a terrestrial digital multimedia broadcasting (T-DMB) receiver using a human body as an antenna, the T-DMB receiver comprising: a first receiver receiving a current, which flows through the human body due to a DMB broadcasting signal, via an electrode making contact with a human body, amplifying the received current, and matching impedance with the human body; a second receiver receiving a DMB broadcasting signal converted to a high frequency signal by a predetermined T-DMB relay apparatus; and a signal selection switch for selecting a DMB broadcasting signal received through the first receiver or the second receiver according to a predetermined selection signal.

According to another aspect of the present invention, there is provided a terrestrial digital multimedia broadcasting (T-DMB) receiving method using a human body, in which a T-DMB signal is received through a T-DMB receiver comprising a pre-determined receiving circuit, the method comprising: matching an impedance of the T-DMB receiver with an impedance of the human body; measuring a current flowing through the human body due to a DMB broadcasting signal after the impedance matching; and amplifying the measured current.

Accordingly, a T-DMB receiver easy to carry without a separate antenna can be implemented.

### MODE FOR INVENTION

A terrestrial digital multimedia broadcasting (T-DMB) receiver and receiving method using a human body antenna will be described more fully with the accompanying drawings, in which exemplary embodiments of the invention are shown.

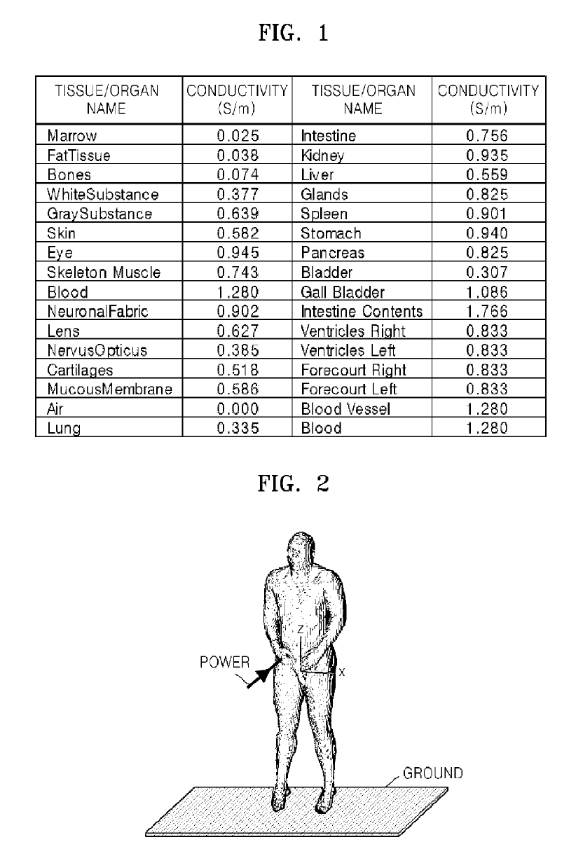

FIG. 1 is a diagram illustrating conductivities of tissues/organs comprising a human body at a T-DMB frequency band of 200 MHz.

Referring to FIG. 1, considering that water at 1.5° C. has conductivity of around 0.047 S/m at 300 MHz, a human body can be a conductive line through which a current flows. In particular, comparing the height of a human body, i.e., 1 to 2 m, to a wavelength l of a 200 MHz band, which is a frequency used for a T-DMB receiver, since a height of 1 to 2 m corresponds to a wavelength of 0.7 to 1.3 l, the human body can be a conductive line having a sufficient length for an antenna.

In addition, since the amplitude of a DMB broadcasting signal, i.e., an electric wave signal, transmitted by a broadcasting base station located far from a user is very small at a user's location due to loss caused by air and a plurality of structures, when a human body is used as an antenna of a portable T-DMB receiver, the amplitude of a current flowing through the human body due to a received electric wave signal is also very small, and therefore the human body is only very slightly affected.

FIG. 2 illustrates a human body model used to simulate an antenna characteristic of a human body.

Referring to FIG. 2, a small power is supplied to a hand of the human body model, and the ground below the feet is modeled with a metal plate. The human body model is modeled with a total of 32 human body tissues and organs of a male adult having a standard body shape, and for typical permittivity and conductivity of the human body tissues and organs used for the model, the values provided by the Federal Communications Commission (FCC) are used.

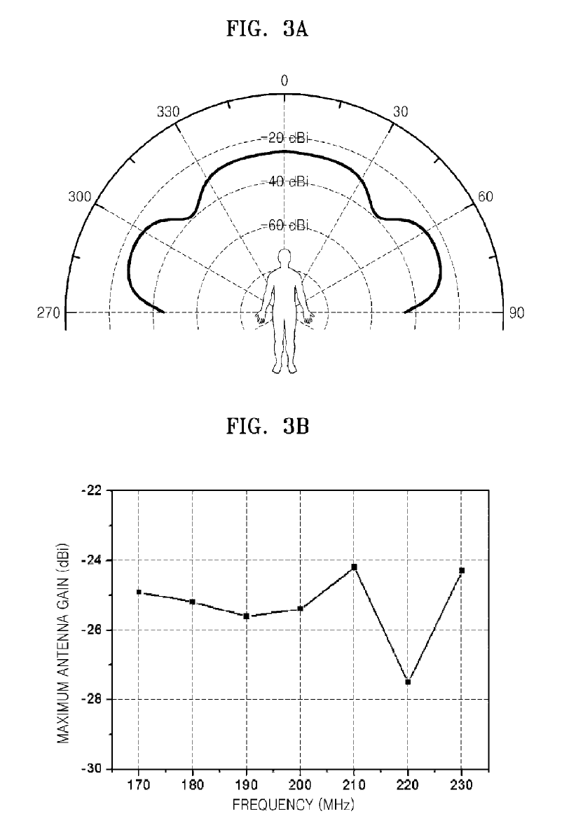

FIGS. 3A and 3B are diagrams illustrating an antenna characteristic of a human body simulated using the human body model of FIG. 2.

Referring to FIG. 3A, a human body antenna has an antenna gain characteristic of more than −40 dBi in all directions except below the ground of FIG. 2 and a maximum of −25.5 dBi.

Referring to FIG. 3B, the human body antenna has a maximum antenna gain characteristic of more than −27.5 dBi in a frequency band of 170 to 230 MHz.

The antenna gain characteristics illustrated in FIGS. 3A and 3B are characteristics when power is supplied to a hand of the human body model of FIG. 2, and even if power is supplied to another part of the human body model, similar antenna gain characteristics can be obtained.

Considering that the maximum antenna gain of an antenna used for a general wireless communication terminal is more than 0 dBi, the human body antenna has a very low antenna gain, and therefore when a signal is received through the human body antenna, the signal loss due to the very low antenna gain results in a very small amplitude of the received signal. To compensate for this signal loss, an amplifier for amplifying the signal received through the human body antenna is required, and it is preferable that the amplifier has a gain of more than 27.5 dB to compensate for the maximum signal loss of around 27.5 dB due to the human body antenna.

In addition, since the human body antenna has a very high input impedance of more than 400 W the impedance matching between an input impedance of the human body antenna and an input impedance of the amplifier is required, and thus an impedance matching circuit must be inserted between the amplifier and the human body antenna.

Unlike an amplifier and an impedance matching circuit used for a general wireless communication terminal, since an amplifier and an impedance matching circuit of a T-DMB receiver using the human body antenna according to an embodiment of the present invention operate at low frequency band of 200 MHz, the amplifier of the T-DMB receiver can have a required gain characteristic in a low power operation. Also, the impedance matching circuit can use small-sized lumped elements, such as inductors and capacitors, instead of distributed elements used for a conventional transmission line, so a small-sized matching circuit can be easily implemented.

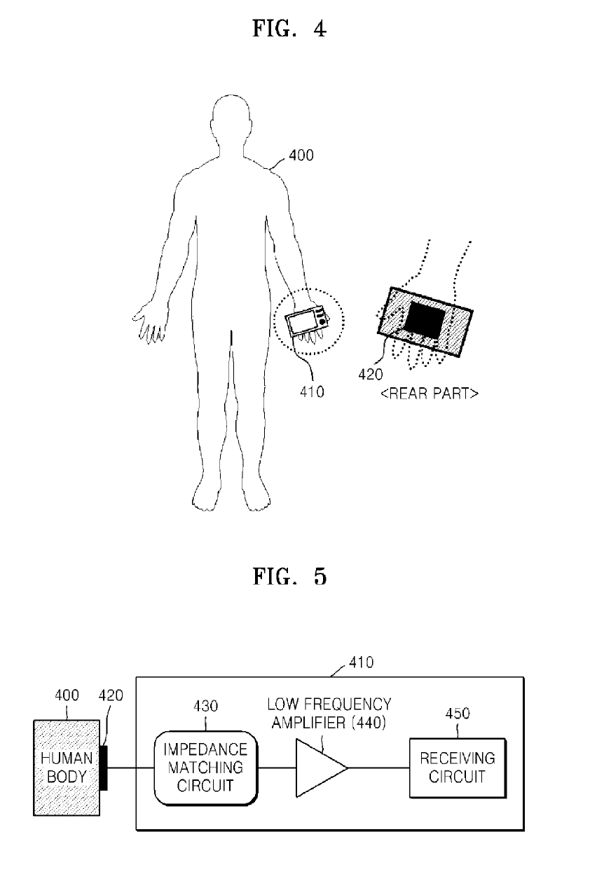

FIG. 4 is a conceptual diagram of a portable T-DMB receiver using a human body 400 as an antenna according to an embodiment of the present invention, and FIG. 5 is a block diagram of the portable T-DMB receiver 410 of FIG. 4 using the human body 400 as an antenna according to the current embodiment of the present invention.

Referring to FIG. 4, while the portable T-DMB receiver 410 according to the current embodiment of the present invention makes contact with a hand of the human body 400, the portable T-DMB receiver 410 can makes contact with another part (for instance, a wrist, a waist, a chest, or a neck) of the human body 400. In addition, an electrode 420 of the T-DMB receiver 410 making contact with the human body 400 can be located at a rear surface of the portable T-DMB receiver 410 or any location on surfaces of the portable T-DMB receiver 410, where the electrode 420 can be formed easily and makes contact with the human body 400.

Referring to FIG. 5, the portable T-DMB receiver 410 is implemented by adding the electrode 420, an impedance matching circuit 430, and a low frequency amplifier 440 to a conventional receiving circuit 450.

The electrode 420 directly makes contact with the human body 400, can be implemented by forming a metal plate on a surface of the portable T-DMB receiver 410, and is formed at a location contacting the human body 400 by a sufficient area among surfaces of the portable T-DMB receiver 410.

The impedance matching circuit 430 matches an impedance of the human body 400 with an impedance of the low frequency amplifier 440. The low frequency amplifier 440 is an amplifier of a low frequency band, receives via the electrode 420 a current flowing through the human body 400 due to a DMB broadcasting signal emitted by a T-DMB broadcasting base station, and amplifies the received current. The amplified signal is input to the receiving circuit 450. Since the low frequency amplifier 440 operates in a low frequency band, it can operate with low power, and since the impedance matching circuit 430 can be implemented with lumped elements, they can both be small sized.

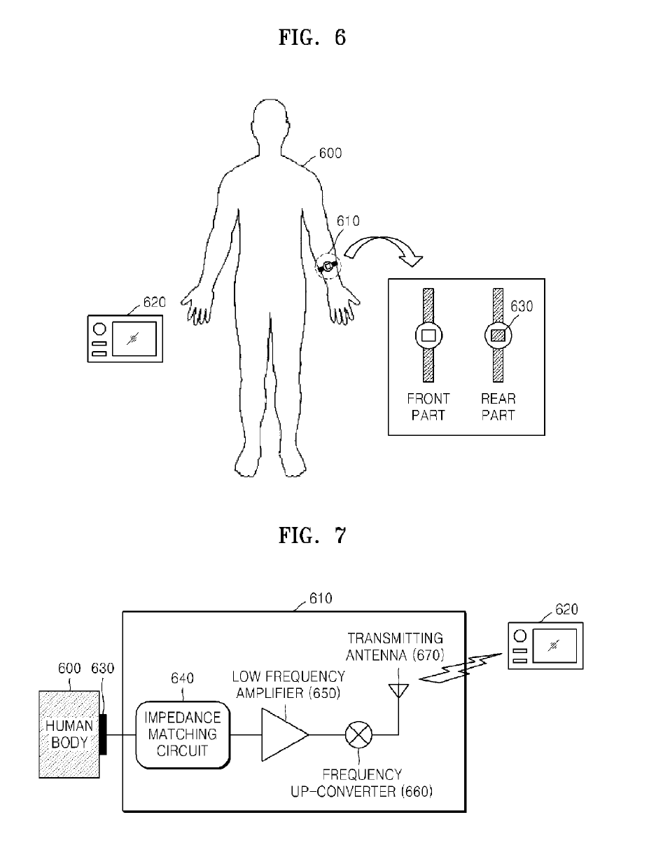

FIG. 6 is a conceptual diagram of a T-DMB receiver 620 and a T-DMB relay apparatus 610 using a human body 600 as an antenna according to another embodiment of the present invention, and FIG. 7 is a block diagram of the T-DMB relay apparatus 610 of FIG. 6 using the human body 600 as an antenna according to the current embodiment of the present invention.

Referring to FIG. 6, the T-DMB receiver 620 according to the current embodiment of the present invention receives DMB data through the T-DMB relay apparatus 610, which converts a signal received via the human body 600 to a signal of high frequency band and transmits the converted signal to the T-DMB receiver 620.

While the T-DMB relay apparatus 610 is located on a wrist of the human body 600, it can make contact with another part of the human body 600. When the T-DMB receiver 620 makes contact with the human body 600, the T-DMB receiver 620 receives DMB data through the human body 600 as the portable T-DMB receiver 410 illustrated in FIGS. 4 and 5. However, if for example a user sits on a chair and is apart from the T-DMB receiver 620 located on a table, the T-DMB relay apparatus 610 worn by the user can transmit a signal of high frequency band to the T-DMB receiver 620. That is, a DMB broadcasting signal received by the T-DMB relay apparatus 610 through the human body 600 is converted to a signal of a high frequency band and transmitted to the T-DMB receiver 620.

Referring to FIG. 7, the T-DMB relay apparatus 610 includes an electrode 630, an impedance matching circuit 640, a low frequency amplifier 650, a frequency up-converter 660, and a transmitting antenna 670. The T-DMB receiver 620 includes a receiver (not shown), which can receive a signal of a high frequency band higher than a frequency of a T-DMB broadcasting signal, so that it can receive a signal transmitted from the T-DMB relay apparatus 610.

Since the electrode 630, the impedance matching circuit 640, and the low frequency amplifier 650 included in the T-DMB relay apparatus 610 have the same configurations and functions of the electrode 420, the impedance matching circuit 430, and the low frequency amplifier 440 illustrated in FIG. 5, a detailed description thereof is omitted.

The frequency up-converter 660 converts a DMB broadcasting signal amplified by the low frequency amplifier 650 to DMB broadcasting signal of high frequency and transmits the converted DMB broadcasting signal to the T-DMB receiver 620 via the transmitting antenna 670.

That is, a process of receiving DMB data includes: amplifying a DMB broadcasting signal received through the human body 600 by passing it through the electrode 630, the impedance matching circuit 640, and the low frequency amplifier 650; converting the amplified signal to a signal of high frequency band using the frequency up-converter 660; and transmitting the converted signal to the T-DMB receiver 620 via the transmitting antenna 670.

According to the current embodiment of the present invention, another amplifier and another frequency converter or other devices for wireless communication can be added to the T-DMB relay apparatus 610 of the current embodiment besides the low frequency amplifier 650 and the frequency up-converter 660, or a deployment sequence of the low frequency amplifier 650 and the frequency up-converter 660 can vary. In addition, the remaining elements except the electrode 630 in the T-DMB relay apparatus 610 can be inserted into an existing device, e.g., a watch, a necklace, or a ring, worn on the human body 600 by being implemented with small-sized elements, and the electrode 630 can be properly formed outside the existing device.

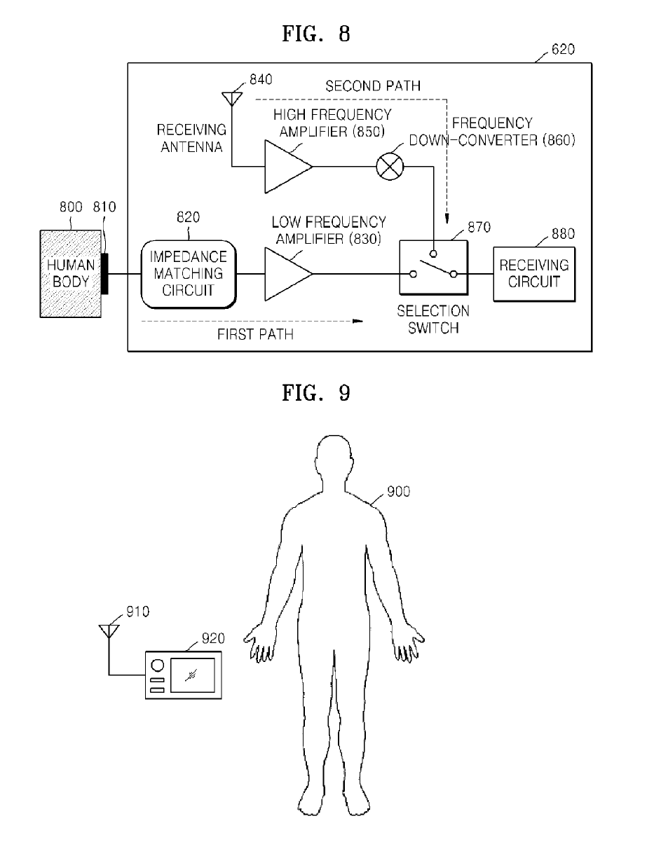

FIG. 8 is a block diagram of a T-DMB receiver using a human body as an antenna according to another embodiment of the present invention.

Referring to FIG. 8, the T-DMB receiver according to the current embodiment of the present invention includes an electrode 810, an impedance matching circuit 820, a low frequency amplifier 830, and a receiving circuit 880 and further includes a receiving antenna 840, a high frequency amplifier 850, a frequency down-converter 860, and a selection switch 870 for receiving DMB data from the T-DMB relay apparatus 610 illustrated in FIG. 6.

That is, the T-DMB receiver illustrated in FIG. 8 is comprised of a first receiver including the electrode 810, the impedance matching circuit 820, and the low frequency amplifier 830, a second receiver including the receiving antenna 840, the high frequency amplifier 850, and the frequency down-converter 860, and the selection switch 870.

The receiving antenna 840 of the second receiver receives a DMB broadcasting signal of high frequency from the T-DMB relay apparatus 610 illustrated in FIG. 6. The high frequency amplifier 850 amplifies the received DMB broadcasting signal of high frequency, and the frequency down-converter 860 converts high frequency band of the amplified signal to a frequency band of an original DMB broadcasting signal.

The selection switch 870 selects one of a DMB broadcasting signal received through the first receiver and a DMB broadcasting signal received through the second receiver according to a user's selection and outputs the selected DMB broadcasting signal to the receiving circuit 880.

According to the current embodiment of the present invention, another amplifier and another frequency converter or other devices for wireless communication can be added to the T-DMB receiver 620 of the current embodiment besides the high frequency amplifier 850 and the frequency down-converter 860, or a deployment sequence of the high frequency amplifier 850 and the frequency down-converter 860 can vary.

When the T-DMB receiver of the current embodiment makes contact with a human body 800, a first path for receiving DMB data through the first receiver is selected using the selection switch 870, and the DMB data is received as illustrated in FIGS. 4 and 5.

On the contrary, when the T-DMB receiver does not make contact with the human body 800, a second path is selected using the selection switch 870, and then a signal of high frequency transmitted from the T-DMB relay apparatus 610 illustrated in FIG. 6 is received through the receiving antenna 840 and amplified by the high frequency amplifier 850. The amplified signal is converted to a DMB broadcasting signal having an original frequency band by the frequency down-converter 860 and outputs to the receiving circuit 880.

The transmitting antenna 670 of the T-DMB relay apparatus 610 according to the previous embodiment and the receiving antenna 840 of the T-DMB receiver according to the current embodiment are used in a high frequency band, and the antenna size is proportional to a wavelength of a used frequency. Accordingly, the two antennas can be small sized.

In addition, since transmission and reception between the T-DMB relay apparatus and the T-DMB receiver according to the previous and current embodiments occur within a distance of several meters, the frequency up-converter 660 used in the previous embodiment and the frequency down-converter 860 and the high frequency amplifier 850 used in the current embodiment can operate with low power. Thus, the T-DMB relay apparatus and the T-DMB receiver according to the embodiments of the present invention can be implemented very easily.

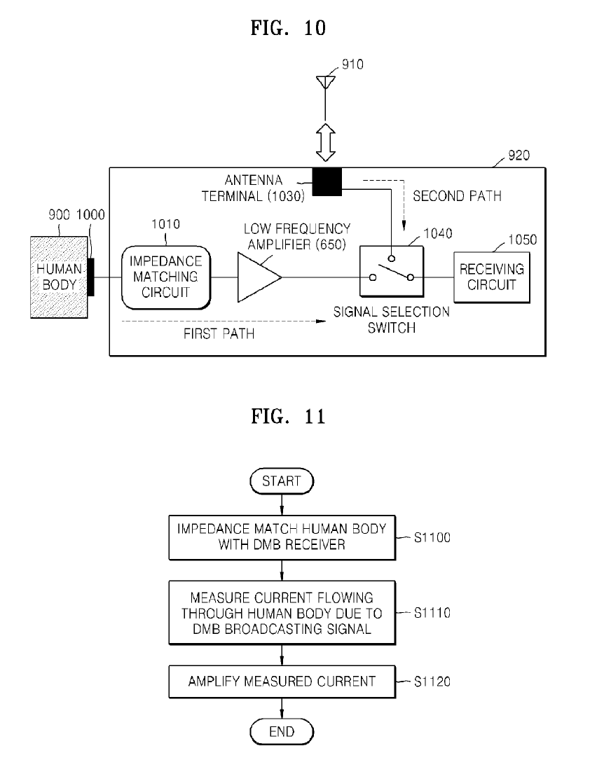

FIG. 9 is a conceptual diagram of a T-DMB receiver 920 using a human body 900 as an antenna according to another embodiment of the present invention, and FIG. 10 is a block diagram of the T-DMB receiver of FIG. 9 using a human body as an antenna according to the current embodiment of the present invention.

Referring to FIGS. 9 and 10, the T-DMB receiver 920 includes the human body 900 as an antenna and a separate antenna 910. The T-DMB receiver 920 includes an electrode 1000 for receiving a DMB signal using the human body 900 as an antenna by making contact with the human body 900, an impedance matching circuit 1010, a low frequency amplifier 1020, an antenna terminal 1030 for receiving DMB data through the separate antenna 910, a signal selection switch 1040 for selecting whether the DMB broadcasting is received through the human body antenna 900 or the separate antenna 910, and a conventional receiving circuit 1050.

When the T-DMB receiver 920 makes contact with the human body 900, a user selects a first path for receiving DMB data via the human body 900 using the signal selection switch 1040. On the contrary, when the T-DMB receiver 920 does not make contact with the human body 900, the user installs the separate antenna 910 and selects a second path for receiving the DMB data through the separate antenna 910 using the signal selection switch 1040. Thus, not only when the T-DMB receiver 920 makes contact with the human body 900 but also when the T-DMB receiver 920 does not make contact with the human body 900, a DMB broadcasting signal can be received.

FIG. 11 is a flowchart of a T-DMB receiving method using a human body as an antenna according to an embodiment of the present invention.

Referring to FIG. 11, in operation S1100, when a human body is used as an antenna, impedance matching between an impedance of the human body and an impedance of a T-DMB receiver is performed. Thereafter, a current flowing through the human body due to a DMB broadcasting signal is measured using an electrode making contact with the human body in operation S1110. Since the measured current is very weak, the measured current is amplified by a low frequency amplifier in operation S1120, and the amplified signal is input to a receiving circuit of a conventional T-DMB receiver.

Besides, a DMB broadcasting signal converted to a high frequency signal by the T-DMB relay apparatus illustrated in FIGS. 6 and 7 can be received, and in this case, a user can select whether a DMB broadcasting signal is received through a human body or from the T-DMB relay apparatus.

While this invention has been particularly shown and described with reference to preferred embodiments thereof, it will be understood by those skilled in the art that various changes in form and details may be made therein without departing from the spirit and scope of the invention as defined by the appended claims. The above-described embodiments should be considered in a descriptive sense only and are not for purposes of limitation. Therefore, the scope of the invention is defined not by the detailed description of the invention but by the appended claims, and all differences within the scope will be construed as being included in the present invention.

1. A terrestrial digital multimedia broadcasting (T-DMB) receiver using a human body as an antenna, the T-DMB receiver comprising:
an electrode making contact with the human body;
a low frequency amplifier receiving via the electrode a current flowing through the human body due to a DMB broadcasting signal emitted by a terrestrial relay station and amplifying the received current; and
an impedance matching circuit located between the electrode and the low frequency amplifier and matching an impedance of the human body with an impedance of the low frequency amplifier.

2. The T-DMB receiver of claim 1, wherein the low frequency amplifier has a gain characteristic of more than a specific value by which loss of the antenna can be compensated for.

3. The T-DMB receiver of claim 1, wherein the impedance matching circuit is implemented using small-sized lumped elements comprising an inductor and a capacitor.

4. The T-DMB receiver of claim 1, further comprising:
an antenna terminal with which a receiving antenna for DMB broadcasting is combined; and
a signal selection switch for selecting one of a DMB broadcasting signal received through the receiving antenna for DMB broadcasting combined with the antenna terminal and a DMB broadcasting signal amplified by the low frequency amplifier.

5. A terrestrial digital multimedia broadcasting (T-DMB) relay apparatus using a human body as an antenna, by which T-DMB data is relayed to a T-DMB receiver comprising a high frequency receiver receiving a signal of a high frequency band higher than a frequency of the T-DMB data, the T-DMB relay apparatus comprising:
an electrode making contact with the human body;
a low frequency amplifier receiving via the electrode a current flowing through the human body due to a DMB broadcasting signal and amplifying the received current;
an impedance matching circuit located between the electrode and the low frequency amplifier and matching an impedance of the human body with an impedance of the low frequency amplifier;
a frequency up-converter converting the current amplified by the low frequency amplifier to a high frequency signal corresponding to the high frequency receiver of the T-DMB receiver; and
a transmitting antenna for transmitting the converted signal of high frequency band.

6. The T-DMB relay apparatus of claim 5, wherein in a watch shaped structure, the electrode is located on a bottom surface of the watch-shaped structure, and the low frequency amplifier, the impedance matching circuit, and the frequency up-converter are located inside the watch-shaped structure.

7. A terrestrial digital multimedia broadcasting (T-DMB) receiver using a human body as an antenna, the T-DMB receiver comprising:
a first receiver receiving a current, which flows through the human body due to a DMB broadcasting signal, via an electrode making contact with the human body, amplifying the received current, and matching impedance with the human body;
a second receiver receiving a DMB broadcasting signal converted to a high frequency signal by a predetermined T-DMB relay apparatus; and
a signal selection switch for selecting a DMB broadcasting signal received through one of the first receiver and the second receiver according to a pre-determined selection signal.

8. The T-DMB receiver of claim 7, wherein the first receiver comprises:
an electrode making contact with the human body;
a low frequency amplifier receiving via the electrode a current flowing through the human body due to a DMB broadcasting signal and amplifying the received current; and
an impedance matching circuit located between the electrode and the low frequency amplifier and matching an impedance of the human body with an impedance of the low frequency amplifier.

9. The T-DMB receiver of claim 7, wherein the second receiver comprises:
a receiving antenna for receiving a DMB broadcasting signal converted to high frequency and transmitted from the T-DMB relay apparatus;
a high frequency amplifier amplifying the DMB broadcasting signal of high frequency; and
a frequency down-converter converting the amplified DMB broadcasting signal to a frequency band of an original DMB broadcasting signal.

10. A terrestrial digital multimedia broadcasting (T-DMB) receiving method using a human body, in which a T-DMB signal is received through a T-DMB receiver comprising a predetermined receiving circuit, the method comprising:
matching an impedance of the T-DMB receiver with an impedance of the human body;
measuring a current flowing the human body due to a DMB broadcasting signal after the impedance matching; and
amplifying the measured current.

11. The method of claim 10, further comprising:
receiving a DMB broadcasting signal converted to high frequency and transmitted from a predetermined T-DMB relay apparatus; and
selecting a signal output from the amplifying or the receiving according to a pre-determined selection signal.
